(19) United States
(12) Patent Application Publication
(10) Pub. No.: US 2008/0298169 A1
(43) Pub. Date: Dec. 4, 2008

(54) ENCLOSURE FOR A BLENDING TOOL OF A MIXING DEVICE

(75) Inventors: Benjamin Henry Branson, III, Mechanicsville, VA (US); Derek Hassell, Lenexa, VA (US)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: Hamilton Beach Brands, Inc., Glen Allen, VA (US)

(21) Appl. No.: 12/130,352

(22) Filed: May 30, 2008

Related U.S. Application Data
(60) Provisional application No. 60/941,397, filed on Jun. 1, 2007.

(51) Int. Cl. B01F 15/00; B26D 7/27

(52) U.S. Cl. 366/205; 53/396; 366/143

(57) ABSTRACT

A mixing device configured for shipment and/or storage includes a base housing at least one motor, a jar removably mountable to the base in an operating configuration for containing foodstuff, and a blade assembly loosely positioned in the jar. The blade assembly has a first surface and an opposing second surface. The second surface of the blade assembly operatively engages that at least one motor in the operating configuration. The device further includes a blending tool operatively connected to the first surface of the blade assembly and an enclosure removably mountable to the first surface of the blade assembly to enclose the blending tool.

### CROSS-REFERENCE TO RELATED APPLICATIONS

The present application claims the benefit of U.S. Provisional Patent Application No. 60/941,397, filed Jun. 1, 2007 and entitled “Blender Blade Cover”, the entire subject matter of which is hereby incorporated by reference.

### BACKGROUND OF THE INVENTION

This invention generally relates to the storage and/or shipment of mixing devices or other such appliances and, more particularly, to an enclosure or blade cover to enclose the blending tool or blade of a blender or other such appliances which reduces the overall size of the packaging used to store and/or ship blenders and reduces the costs associated with storage and/or shipment of mixing devices or other such appliances.

It is generally known that blenders include a multitude of small parts that must be protected during storage and/or shipment to assure that the blender properly functions once it reaches the end user. Blenders are often constructed and assembled by a manufacturer and then shipped to a retailer or end user in the final operating configuration. For example, the manufacturer may assemble the blender such that a motor is mounted within a base of the blender, a blade assembly, including a cutting blade or tool, is operatively positioned within ajar, and the jar is positioned on top of the base such that the cutting blade of the blade assembly is operatively connected to a collar. This assembled blender is then placed in a box, a package or other shipping material and sent to the retailer or end user. When shipped or stored in the above-described configuration, the price of shipping or storage of the blender can be quite high due to the overall size of the blender and the need to protect the components inside the blender. Further, the fully assembled blender located within the enclosed packaging can be quite cumbersome for a shipper, retailer or end user to transport or carry.

Therefore, it would be desirable to create a blender that includes components that can be stored and/or shipped in a relatively compact manner such that the costs associated with shipping or storage will be decreased and the final packaging can be more conveniently handled or transported. Specifically, it would be desirable to create a blender such that the collar or blade assembly can be temporarily and/or loosely placed within the jar of the blender during shipment to reduce the overall size of the package and cost of the shipment. Further, it would be desirable to protect the blending blades and rotary shaft of the blade assembly during storage or shipment of the blender to assure that these components are not damaged during shipment. Further, it would be desirable to create a blade cover to enclose the blade assembly of the blender to prevent the retailer or end user from injuring themselves on the blades during opening of the packaging.

### BRIEF SUMMARY OF THE INVENTION

The present invention is directed to a mixing device configured for shipment and/or storage. The device includes a base housing at least one motor, ajar removably mountable to the base in an operating configuration for containing foodstuff, and a blade assembly loosely positioned in the jar. The blade assembly has a first surface and an opposing second surface. The second surface of the blade assembly operatively engages the at least one motor in the operating configuration. The device further includes a blending tool operatively connected to the first surface of the blade assembly and an enclosure removably mountable to the first surface of the blade assembly to enclose the blending tool.

In another aspect, the present invention is directed to a method of shipping and/or storing a mixing device configured to blend foodstuff. The method including the steps of providing a partially disassembled mixing device. The mixing device including a base, ajar, a blending tool operatively engaged to a blade assembly and an enclosure. The method further including the steps of removably securing the enclosure to the blade assembly to enclose the blending tool, inserting the enclosure and blade assembly loosely into an interior of the jar, inverting the jar, and placing the inverted jar over the base such that the mixing device is in a partially assembled state to reduce the overall size of the mixing device for shipping and/or storage purposes.

### BRIEF DESCRIPTION OF THE SEVERAL VIEWS OF THE DRAWINGS

The following detailed description of preferred embodiments of the invention will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a front elevation view of an enclosure and blade assembly of a mixing device in accordance with a first preferred embodiment of the present invention;

FIG. 1A is a cross-sectional elevation view of the enclosure and blade assembly shown in FIG. 1, taken along line A-A of FIG. 1;

FIG. 2 is a cross sectional perspective view of the enclosure and blade assembly shown in FIG. 1, taken along line A-A of FIG. 1;

FIG. 3 is a bottom perspective view of the enclosure shown in FIG. 1;

FIG. 4 is a front right perspective view of a mixing device used in conjunction with the enclosure of the first preferred embodiment;

FIG. 5 is a bottom perspective view of a jar of the mixing device used in conjunction with the enclosure of the first preferred embodiment;

FIG. 6 is a top perspective view of a base of the mixing device used in conjunction with the enclosure of the first preferred embodiment;

FIG. 7 is a top perspective view of a enclosure in accordance with a second preferred embodiment of the present invention;

FIG. 8 is a top perspective view of the enclosure shown in FIG. 7, wherein the enclosure is rotated for clarity; and

FIG. 9 is a top perspective view of the enclosure and a blade assembly in accordance with the second preferred embodiment of the present invention.

### DETAILED DESCRIPTION OF THE INVENTION

Certain terminology is used in the following description for convenience only, and is not limiting. The words “right,” “left,” “upper,” and “lower” designate directions in the drawings to which reference is made. The terminology includes the words above specifically mentioned, derivatives thereof, and words of similar import.

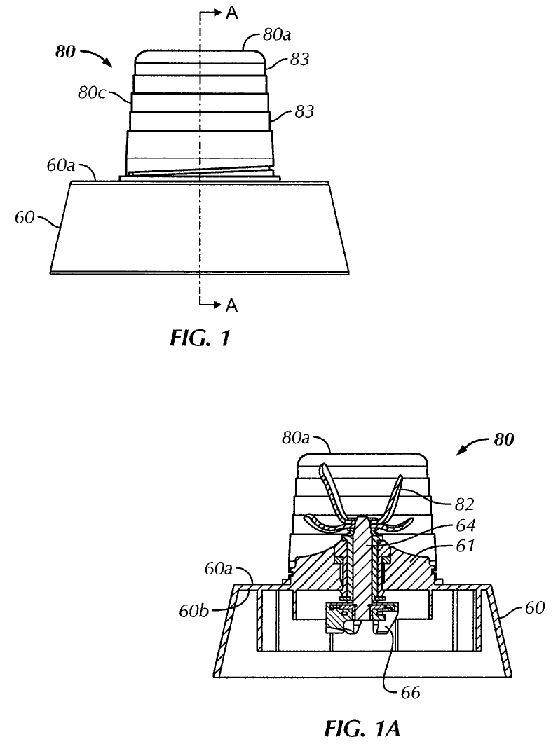

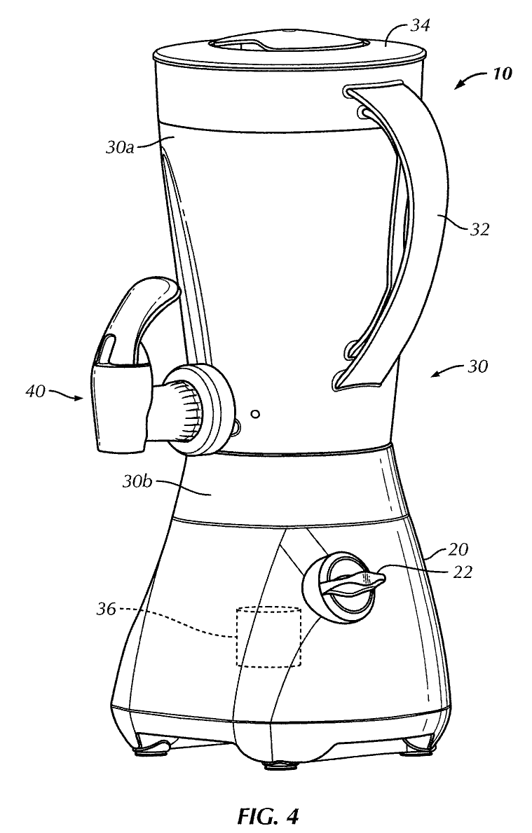

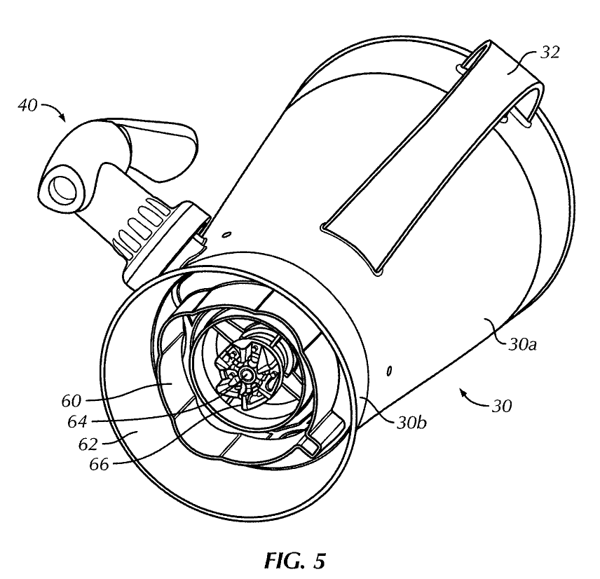

Referring to the drawings in detail where in like numerals indicate like elements throughout, there is shown in FIGS. 1-3 a first preferred embodiment of an enclosure or blade cover, indicated generally at 80, and a cutter or blade assembly, indicated generally at 60, in accordance with the present invention. The blade cover 80 and blade assembly 60 of the first preferred embodiment are preferably used in conjunction with a mixing device or blender configured for shipping and/or storage purposes, indicated generally at 10, and as shown in FIGS. 4-6. It is understood by those skilled in the art that the blade cover 80 and blade assembly 60 are not limited to being used in conjunction with the blender 10 as shown in the figures, but can be used with virtually any food processor, blender apparatus or other such appliance without departing from the spirit and scope of the invention.

Referring to FIGS. 4-6, the blender 10 used in conjunction with the enclosure 80 and blade assembly 60 of the present invention preferably includes a blender base 20 and a blender container 30. The blender base 20 includes a control dial 22 to allow the user to selectively operate at least one motor 36 housed within the base 20. The container 30 includes ajar 30a and a collar 30b which may be integrally formed thereto. The jar 30a is removably mountable to the base 20 in an operating configuration (FIG. 4) for containing foodstuff. The container 30 may also include a handle 32 and a removable lid 34. The container 30 may further include a dispensing assembly 40. In the present embodiment, the dispensing assembly 40 is mounted to the jar 30a. However, it is understood by those skilled in the art that the dispending assembly 40 may be mounted to the collar 30b and/or the blade assembly 60 (as shown in FIG. 9).

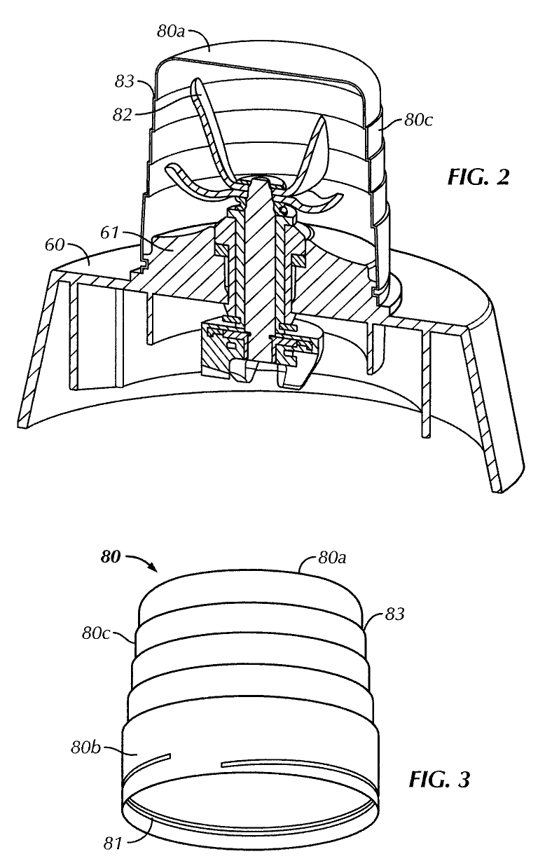

The blade assembly 60 is preferably threadably mounted within the jar 30a and/or collar 30b when the mixing device 10 is in the operating configuration. The blade assembly 60 has a first, upper surface 60a and an opposing second, lower surface 60b. The second surface 60b operatively engages the at least one motor 36 when the mixing device 10 is in the operating configuration. The blade assembly 60 further includes a blending tool 82 operatively connected to the first surface 60a. The blending tool 82 extends into the jar 30a for rotation within the container 30 to blend the foodstuff when the mixing device 10 is in the operating configuration. The blending tool 82 is preferably in the form of a blending blade (or multiple blades as shown in FIGS. 1A and 2). However, the blending tool 82 may be in virtually any form, such as disc slicer, for example, without departing from the spirit and scope of the present invention. A tool shaft 64 having a tool clutch 66 extends into a space surrounded by the blade assembly 60. The base 20 may include an upwardly extending base wall 21 and a motor shaft 70 and a motor clutch 72 extend into a space surrounded by the base wall 21. A base rim 74 extends around the bottom of the base wall 21.

Blenders similar to the above-described configuration are generally constructed and assembled by the manufacturer and placed in a package or box in a fully assembled configuration (FIG. 4) for shipment and/or storage purposes. However, storing and shipping blenders to the end user in a fully assembled configuration (i.e. FIG. 4) can be costly to the manufacturer and awkward or cumbersome for the retailer or end-user to carry or transport. Therefore, to reduce storage and shipment costs, the manufacturer of the above-described blender can ship and/or store the blender 10 in a partially disassembled configuration to save shipment and/or storage costs. For example, the manufacturer can reduce the overall size of the blender 10 by placing the blade assembly 60 loosely within the internal cavity of the jar 30a or container 30 such that the overall height of the blender 10 can be reduced to avoid excess shipment or storage costs. Further, the enclosure or blade cover 80 protects the blending blade 82 and the retailer, manufacturer, or end user from injuring themselves on the sharp blending blade 82 when assembling or disassembling the blender 10.

Referring specifically to FIGS. 1-3, the enclosure 80 of the first preferred embodiment is removably mountable to the first surface 60a of the blade assembly 60 to at least partially enclose the blending tool 82. Specifically, the enclosure 80 is generally sized and shaped to enclose the blending blade 82 with the first surface 60a of the blade assembly 60 by matingly engaging a surface of the blade assembly 60. The blade cover 80 is generally frusto-conical in shape, or cup-shaped, and has an upper enclosed end 80a, a lower open end 80b and an outer sidewall 80c therebetween. However, it is understood that those skilled in the art that the size and shape of the blade cover 80 can be modified without departing from the spirit and scope of the invention.

The blade cover 80 of the first preferred embodiment includes at least one rib 83 on an exterior surface of the blade cover 80, or outer sidewall 80c, to assist the manufacturer, retailer or end user in grasping the blade cover 80. Preferably, the outer sidewall 80c of the enclosure 80 includes a progression of spaced apart ribs 83, such that a lower rib has a slightly larger diameter than its adjacent higher rib. It is understood by those skilled in the art that the blade cover 80 is not limited to the inclusion of ribs 83. Further, it is within the spirit and scope of the invention that the blade cover 80 may include virtually any other structure to increase a user's ability to grip the blade cover 80.

The blade cover 80 is preferably formed of a high-strength, light-weight material, such as Styrene Acrylonitrile (SAN), ABS, or any other polymeric material. However, it is understood by those skilled in the art that the blade cover 80 can be formed of virtually any material, such as metallic material or cardboard material, which can provide protection to the blending blade 82 without departing from the spirit and scope of the invention. The enclosure 80 of the first preferred embodiment is preferably disposable to save the manufacturer money during construction and assembly of the blender 10. However, it is understood by those skilled in the art that the blade cover 80 may be constructed to be reusable by either the manufacturer or the end user for various purposes. For example, the end user may use the blade cover 80 to cover the blending blade(s) 82 during storage of the blender 10 on a counter or in a cabinet.

As shown in FIGS. 1A and 2, the enclosure 80 of the first preferred embodiment is removably engagable to the blade assembly 60. Specifically, the blade cover 80 of the first preferred embodiment has an internal thread 81 on the second end 80b to matingly engage an exterior surface of an upper portion 61 of the blade assembly 60 and to assure that the blade cover 80 can be securely removable to the blade assembly 60. However, it is understood by those skilled in the art that the blade cover 80 can be removably mounted to the blade assembly 60 by virtually any method, such as friction fit, rivets, screws, bolts, adhesive, etc., without departing from the spirit and scope of the present invention. Further, it is within the spirit and scope of the present invention that the enclosure 80 may have external threads (not shown) to mate with the threads (not shown) of the blade assembly 60 that face inwardly toward the center of the blade assembly 60. Those skilled in the art would understand that various thread configurations can be used on the blade cover 80 so that the blade cover 80 can be used in conjunction with various cutter or blade assemblies used on different blenders.

Preferably, the overall size of the enclosure 80 is not larger than necessary to fully enclose the blending blade 82 on top of the blade assembly 60. One skilled in the art would understand that a smaller blade cover 80 reduces the overall packaging of the blender 10 and reduces storage and/or shipment costs. It is understood by those skilled in the art that the size and shape of the blade cover 80 can be modified without departing from the spirit and scope of the invention. For example, the blade cover 80 may be generally rectangular, triangular or virtually any other shape suitable for enclosing the blending blade 82 without departing from the spirit and scope of the invention. In the present embodiment, the enclosure 80 is preferably generally opaque such that the user cannot generally view the blending blade 82 when the enclosure 80 is mounted to the blade assembly 60. Alternatively, the enclosure 80 may be formed of a generally transparent or translucent material such that the user can view the blending blade 82 when the enclosure 80 is mounted to the blade assembly 60.

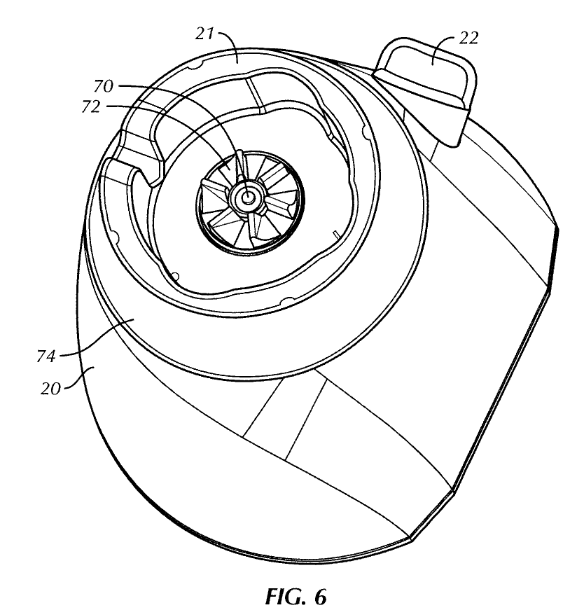

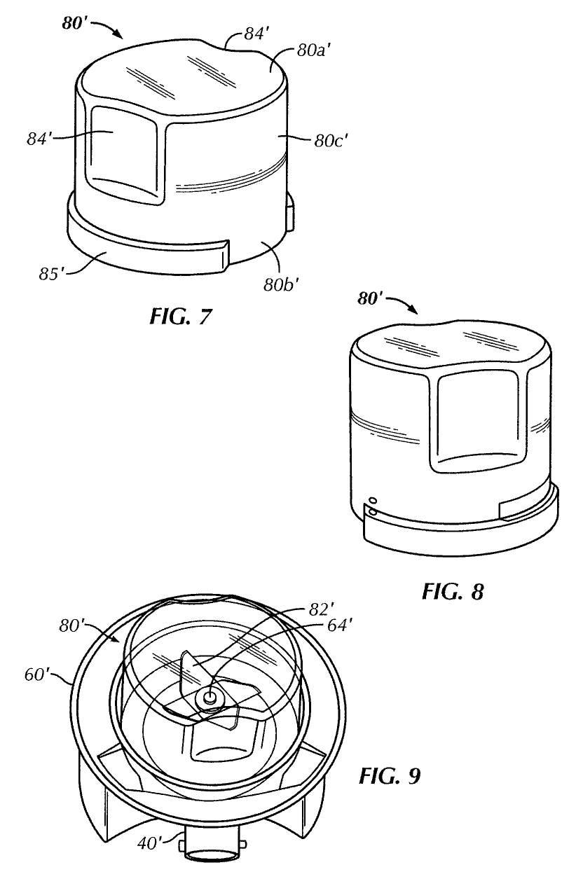

Referring to FIGS. 7-9, a second preferred embodiment of the enclosure 80′ is shown, including like reference numerals to indicate like elements and a prime symbol (′) distinguishing the reference numerals of the second preferred embodiment from the first preferred embodiment. Similar to the first preferred embodiment, the second preferred embodiment of the enclosure or blade cover 80′ is used to enclose the blending blades 82′ within the cutter or blade assembly 60′. However, the blade cover 80′ of the second preferred embodiment preferably includes at least one grip indentation 84′ on the outer sidewall 80c′ to assist the manufacturer, retailer, or end user in grasping the blade cover 80′. Specifically, the outer sidewall 80c′ or outer surface of the enclosure include two spaced-apart grip indentations 84′, such that each grip indentation 84′ is located on an opposing side of the enclosure 80′ around the circumferential perimeter of the enclosure 80′. The grip indentations 84′ provide a slot or recess generally sized to received a finger and/or thumb of a user.

As seen in FIG. 7, the blade cover 80′ of the second preferred embodiment includes at least one locking ridge 85′ on the exterior of the lower open end 80b′ to allow the blade cover 80′ to be removably engaged with the blade assembly 60′. Specifically, the at least one locking ridge 85′ orthogonally extends from an exterior surface of the blade cover 80′ to create a spacing to engage a slot (not shown) or projection (not shown) on the blade assembly 60′ to allow the blade cover 80′ to be snapped on or removably engaged with the blade assembly 60′. However, similar to the first preferred embodiment, the second preferred embodiment of the blade cover 80′ may include internal or external threads (not shown) such that the blade cover 80′ may be removably engaged with an upper portion (not shown) of the blade assembly 60′. As seen in FIG. 7, the enclosure 80′ of the present embodiment preferably includes two spaced apart locking ridges 85′, such that each locking ridge 85′ is located on an opposing side of the enclosure 80′ around the circumferential perimeter of the enclosure 80′.

In the present embodiment, the enclosure 80′ is preferably formed of a generally transparent or translucent material such that the user can view the blending blade 82′ when the enclosure 80′ is mounted to the blade assembly 60′. Alternatively, the enclosure 80′ may be generally opaque, such that the user cannot generally view the blending blade 82′ when the enclosure 80′ is mounted to the blade assembly 60′.

In operation, the manufacturer or supplier produces/creates the various components of the blender 10 in the typical fashion. However, before the manufacturer or supplier fully assembles the blender 10 to be placed in the packaging or container for storage or shipment, the manufacturer or supplier provides a partially disassembled mixing device 10, wherein the base 20, jar 30a, blending tool 82, 82′ that is operatively engaged to the blade assembly 60, 60′ and enclosure 80, 80′ are not connected or combined in the typical operating configuration. Specifically, the manufacturer or supplier removably secures or places the enclosure 80, 80′ onto the first or top surface 60a, 60a′ of the blade assembly 60, 60′ to enclose the blending tool 82, 82′. Next, instead of threadably inserting the blade assembly 60, 60′ and blending blade 82, 82′ into the lower portion of the container 30 (as one would do to put the mixing device in the operating configuration), the manufacturer or retailer places the assembled blade assembly 60, 60′ and blade cover 80, 80′ loosely into an interior of the jar 30a or container 30. Next, the manufacturer or supplier places the container 30 within the packaging or shipment material with the rest of the blender 10 components. Preferably, the container 30 is inverted and placed over the base 20 to reduce the overall size of the partially mixing device 10 for packaging and/or storing. In this configuration, the mixing device 10 is can be said to be in a partially assembled state, such that the end user or customer is required to make only minor or trivial adjustments/rearrangements to quickly and conveniently assemble the mixing device 10 in the operating configuration (FIG. 4). This partially assembled configuration reduces the overall height of the mixing device 10 as compared to conventional blender packaging methods and reduces the storage and shipment costs to the manufacturer, supplier and consumer. The partially assembled mixing device 10 may be placed into packaging, such as a cardboard box, for example, such that the mixing device 10 is protected during shipment and/or storage.

Once the end user or consumer receives the packaging containing the partially disassembled blender 10, the user removes the various components of the blender 10 and assembles them in accordance with supplied instructions. Specifically, the end user will disengage the threads 81 or locking ridges 85′ of the blade cover 80, 80′ from the blade assembly 60, 60′ to expose the blending blade 82, 82′. Next, the end user will insert the blade assembly 60, 60′ and blending blade 82, 82′ into the lower portion of the container 30 to create the assembled container 30 (FIG. 4). Once the rest of the blender 10 components are assembled and the container 30 is placed on top of the fully assembled blender base 20 and power is supplied to the blender 10, foodstuff is ready to be blended. As a result of the blade cover 80, 80′, the overall storage and/or shipment costs of the blender have been reduced. In addition, the manufacturer, retailer or end users hands have been protected from direct contact with the blending blade 82, 82′.

It will be appreciated by those skilled in the art that changes could be made to the embodiment described above without departing from the broad inventive concept thereof. It is understood, therefore, that this invention is not limited to the particular embodiment disclosed, but is intended to cover modifications within the spirit and scope of the present invention as described by the appended claims.

I/we claim:

1. A mixing device configured for shipment and/or storage, said device comprising:
a base housing at least one motor;
a jar removably mountable to said base in an operating configuration for containing foodstuff;
a blade assembly loosely positioned in said jar, said blade assembly having a first surface and an opposing second surface, said second surface of said blade assembly for operatively engaging said at least one motor in said operating configuration;
a blending tool operatively connected to said first surface of said blade assembly; and
an enclosure removably mountable to said first surface of said blade assembly to enclose said blending tool.

2. A device in accordance with claim 1, wherein said enclosure has a first closed end, a second open end and an outer sidewall therebetween.

3. A device in accordance with claim 2, wherein said enclosure further includes a threaded surface on said second open end for removably engaging a threaded surface of said blade assembly.

4. A device in accordance with claim 2, wherein said outer sidewall of said enclosure includes at least one rib to assist in gasping the enclosure.

5. A device in accordance with claim 4, wherein said outer sidewall of said enclosure includes a plurality of spaced-apart ribs.

6. A device in accordance with claim 2, wherein said outer sidewall of said enclosure includes at least one grip indentation to assist in grasping the enclosure.

7. A device in accordance with claim 6, wherein said outer sidewall of said enclosure includes two spaced-apart grip indentations.

7. A device in accordance with claim 2, wherein said outer sidewall of said enclosure includes as least one locking ridge to removably engage a portion of said blade assembly.

8. A device in accordance with claim 7, wherein said outer sidewall of said enclosure includes two-spaced apart locking ridges.

9. A device in accordance with claim 1, wherein said enclosure has a frusto-conical shape.

10. A device in accordance with claim 1, wherein said enclosure is formed of a polymeric material.

11. A device in accordance with claim 10, wherein said enclosure is transparent.

12. A device in accordance with claim 10, wherein said enclosure is opaque.

13. A method of shipping and/or storing a mixing device configured to blend foodstuff, said method comprising the steps of:
a) providing a partially disassembled mixing device, said mixing device comprising a base, a jar, a blending tool operatively engaged to a blade assembly and an enclosure,
b) removably securing said enclosure to said blade assembly to enclose said blending tool;
c) inserting said enclosure and blade assembly loosely into an interior of said jar;
d) inverting said jar; and
e) placing said inverted jar over said base such that said mixing device is in a partially assembled state to reduce the overall size of the mixing device for shipping or storage purposes.

14. A method in accordance with claim 13, further comprising the step of:
f) placing the partially assembled mixing device into a packaging to be shipped and/or stored.
